(19) United States
(12) Patent Application Publication
(10) Pub. No.: US 2014/0263096 A1
(43) Pub. Date: Sep. 18, 2014

(54) PROCESS FOR CHEMICAL DESTRUCTION OF COMPOUNDS FROM AMINE-BASED CARBON CAPTURE

(71) Applicants: Kolbjørn Zahlsen, Trondheim (NO); Bernd Wittgens, Trondheim (NO); Aslak Einbu, Trondheim (NO)

(72) Inventors: Kolbjørn Zahlsen, Trondheim (NO); Bernd Wittgens, Trondheim (NO); Aslak Einbu, Trondheim (NO)

(73) Assignee: SINVENT AS, Trondheim (NO)

(21) Appl. No.: 14/117,300

(22) PCT Filed: Jun. 13, 2012
(86) PCT No.: PCT/EP12/61233

§ 371 Date: Mar. 25, 2014

(30) Foreign Application Priority Data
Jun. 15, 2011 (EP) 11170064.7

(51) Int. Cl. C02F 1/70

(52) U.S. Cl. CPC C02F 1/705
USPC 210/757; 210/150

(57) ABSTRACT

The present invention provides a liquid handling system comprising a reactor, wherein the reactor is structured such that it contains a gaseous phase and an aqueous phase, both phases being in contact with a heterogeneous hydrogenation catalyst immobilised or suspended within the aqueous phase, wherein the gaseous phase comprises hydrogen and wherein the aqueous phase comprises (i) a solution of amines; and (ii) nitrosamine and/or nitramine compounds resulting from amine-based gas sweetening processes. The invention further relates to a process for in-situ destruction of compounds in the aqueous phase from a scrubber system, wherein the process comprises contacting the aqueous phase with a gas phase comprising hydrogen and a heterogeneous catalyst, wherein the aqueous phase comprises (i) a solution of amines; and (ii) nitrosamine and/or nitramine compounds resulting from amine-based gas sweetening.

### FIELD OF THE INVENTION

The present invention relates to an integrated liquid treatment system and process for in situ destruction of pollutants from gas scrubber systems, such as CO₂-absorption systems, from which environmentally-adverse compounds resulting from amine-based carbon capture are released.

### BACKGROUND TO THE INVENTION

The capture of CO₂ from industrial gases, such as flue gases from power plants, refineries, petrochemical plants and natural gas processing plants is of significant environmental interest as a means of reducing or minimizing climate change resulting from man-made emissions.

Processes of amine gas treatment or acidic gas removal (also known as gas sweetening) have been developed, and these processes use aqueous solutions of amines to remove H₂S and CO₂ from gases.

Gas sweetening takes place in absorber devices, also known as “wet scrubbers”. Wet scrubbers are one of the primary devices that control gaseous emissions, especially acid gases, by using liquid to wash unwanted pollutants from the gas stream.

Carbon capture processes that have been developed based on aqueous amine solutions are technically and economically feasible; however the reduction of CO₂ in the flue gas is often accompanied by emissions of other environmentally-adverse compounds which are formed during the process, for example, as a result of degradation reactions and are emitted from the scrubber of a CO₂-absorption system. Degradation reaction products, which include but are not limited to, nitrosamines and nitramines are formed in the process through complex chemical reaction of compounds present. The chemistry of nitrosamine formation and reaction pathways are described in the literature; e.g.: Douglas et. al. “The chemistry of nitrosamine formation, inhibition and destruction” J. Soc. Cosmet. Chem., 29, 581-606; 1978.

Nitrosamines and nitramines (together with amines and degradation products of amines, and other related species) can be present to some extent in the fluids of an amine-based carbon capture process. The compound concentration can build up in the liquid streams of the carbon-capture process, such as the absorption liquid and reclaimed waste. Emissions of the environmentally-adverse compounds to the air occur either as gaseous compounds, as liquid droplets or adsorbed on particles carried in the flue gas stream exiting the carbon capture process

N-nitrosamines are carcinogenic, and nitramines are potentially carcinogenic; both are highly undesirable in emissions, such as emissions from amine-based carbon capture. It is therefore of great importance to eliminate the emission of nitrosamines and nitramines to air.

Frierdich et al. (Environ. Sci. Technol. 2008, 42, 262-269) describes a process for the destruction of NDMA (N-Nitrosodimethylamine) and the chemically related nitrosamines NDEA, NDPA, NDBA and NDPhA in drinking water, by use of a nickel catalyst and hydrogen in the following reaction:

[chemical structure]

U.S. Pat. No. 4,661,179 describes a method to destroy nitramines in the effluent from waste explosive handling by means of catalytic hydrogenolysis.

In order to address the environmental concerns associated with the release of nitrosamine and nitramine compounds produced as a result of the amine-based carbon capture process, there is a need for the development of processes to enable the efficient removal of these groups of compounds from CO₂-absorption systems.

### SUMMARY OF THE INVENTION

According to a first aspect, the invention provides a liquid handling system comprising a reactor, wherein the reactor is structured such that it contains a gaseous phase and an aqueous phase, both phases being in contact with a heterogeneous hydrogenation catalyst immobilised or suspended within the aqueous phase, wherein the gaseous phase comprises hydrogen and wherein the aqueous phase comprises (i) a solution of amines; and (ii) nitrosamine and/or nitramine compounds resulting from amine-based gas sweetening processes. Preferably, the nitrosamine compounds in the aqueous phase include any compound comprising the group NNO and the nitramine compounds in the aqueous phase include any compound comprising the group NNO₂. Preferably the nitrosamine compounds include any compound having the general formula Rᵢ—N—N═O where i is an integer from 1 to 3 (R—N—N═O, R₁,R₂—N—N═O or R₁,R₂,R₃—N—N═O). Preferably the nitramine compounds include any compound having the general formula Rᵢ—N—N═O, where i is an integer from 1 to 3 (e.g.: R—N—N═O, R₁,R₂—N—N═O or R₁,R₂,R₃—N—NO₂). The one, two or three R groups are each independently selected from the following groups: alkyl; aryl; alkanol; carbonyl; and hydrogen. The system of the invention enables nitrosamine and/or nitramine compounds present in the aqueous phase to be destroyed in situ before they are released into the atmosphere.

According to a second aspect, the invention provides a process for in-situ destruction of in the aqueous phase from a wet scrubber system, wherein the process comprises contacting the aqueous phase with a gas phase and a heterogeneous hydrogenation catalyst, wherein the gas phase comprises hydrogen and wherein the aqueous phase comprises (i) a solution of amines; and (ii) nitrosamine and/or nitramine compounds resulting from amine-based gas sweetening.

### DESCRIPTION OF THE DRAWINGS

FIG. 1 is a schematic illustration of an embodiment the system of the invention showing the reactor only;

FIG. 2 is a schematic illustration of an embodiment the system of the invention showing the reactor connected via a loop to a wet scrubber tower. This embodiment enables the removal of compounds from liquid circulating in wash water section;

FIG. 3 is a schematic illustration of an embodiment the system of the invention showing the reactor connected to the return line of “lean amine” from the amine recovery system to the absorption tower for gas sweetening. The embodiment is shown in a parallel loop implementation; however the invention is not limited to this configuration;

FIG. 4 is a schematic illustration of an embodiment the system of the invention showing the reactor connected to the line of “loaded amine” from the wet scrubber tower for gas sweetening to the amine recovery system. The embodiment is shown in a parallel loop implementation; however the invention is not limited to this configuration; and

FIG. 5 is a schematic illustration of an embodiment the system of the invention showing the implementation of the reactor connected in parallel to the reboiler of the amine recovery system. This embodiment enables the removal of compounds from the re-boiler of desorption tower.

### DETAILED DESCRIPTION OF THE INVENTION

The present invention is based on the surprising realization that the methods described by Frierdich et al. for eliminating nitrosamine compounds from drinking water and U.S. Pat. No. 4,661,179 for eliminating of nitramines from waste explosive disposal can be adapted and applied to an entirely different field, specifically the removal of nitrogen-containing compounds in the aqueous phase of an amine-based carbon capture process. The present inventors have found that it is possible to reduce emission of both nitrosamines and nitramines from, for example, CO₂-absorption plants to the environment to a level below the detection limit of the most sensitive instruments such as Liquid Chromatography Mass Spectroscopy with Triple Quadrupole mass analyser (LC-MS-MS-QQQ). Consequently, the invention has significant environmental benefits.

According to a first aspect, the invention provides a liquid handling system comprising a reactor, wherein the reactor contains a gaseous phase and an aqueous phase, both phases being in contact with a heterogeneous hydrogenation catalyst immobilised or suspended within the aqueous phase, wherein the gaseous phase comprises hydrogen and wherein the aqueous phase comprises (i) a solution of amines; and (ii) nitrosamine and/or nitramine compounds resulting from amine-based gas sweetening processes.

As used herein, the term “gas sweetening process” is intended to have its usual meaning in the art, referring to processes that use aqueous amine solutions to remove H₂S and CO₂ from gases.

The terms “scrubber”, “wet scrubber” and “absorption tower” are used synonymous in the context of the present invention. These terms are intended to have their usual meaning in the art, describing the device used to remove pollutants from a flue gas stream.

The aqueous phase comprises (i) a solution of amines; and (ii) nitrosamine and/or nitramine compounds.

As used herein, the term “amine” includes primary, secondary, tertiary and/or quaternary amines. Primary amines have the general formula R—NH₂. Secondary amines have the general formula R₁,R₂—NH. Tertiary amines have the general formula (R₁,R₂,R₃)—N. Quaternary amines have the general formula (R₁, R₂, R₃, R₄)—N⁺. The one, two, three or four R groups are each independently selected from the following groups: alkyl; aryl; alkanol; carbonyl; and hydrogen.

Examples of amine compounds include, but are not limited to, mono-ethanol-amine (MEA), di-ethanol-amine (DEA) methyl-di-ethanol-amine (MDEA), di-iso-propyl-amine (DIPA), diglycolamine (DGA), piperazine, 2-amino-2-methyl-1-propanol (AMP) and di-methyl-mono-ethanol-amine (DMMEA).

As used herein, the term “nitrosamine” refers to any compound comprising or characterised by the group NNO. This includes any compound having the general formula Rᵢ—N—N═O, wherein i is an integer from 1 to 3 (e.g.: R—N—N═O, R₁,R₂—N—N═O or R₁,R₂,R₃—N—N═O). The one, two or three R groups are each independently selected from the following groups: alkyl; aryl; alkanol; carbonyl; and hydrogen.

Examples of specific nitrosamine compounds include, but are not limited to: N-Nitrosodimethylamine (NDMA); N-Nitrosodiethylamine (NDEA); N-Nitrosodi-n-propylamine (NDPA); N-Nitrosodi-n-butylamine (NDBA); N-Nitrosopiperidine (NPIP); N-Nitrosopyrollidine (NPYR); N-Nitrosomorpholine (NMOR); N-Nitrosomethylethylamine (NMEA); N-Nitrosoiisopropylamine (NDiPA); N-Nitrosomethyl-n-butylamine (NMBA); N-Nitrosomethyl-n-butylamine (NEBA); N-Nitroso-n-propyl-n-butylamine (NPBA); N-Nitrosodiamylamine (NDAmA); N-Nitrosodiethanolamine (NDELA); N-Nitrosopiperazine (NPZ); and 1,4-Dinitrosopiperazine (NDiPZ).

As used herein, the term “nitramine” refers to any compound comprising or characterised by the group NNO₂. This includes any compound having the general formula Rᵢ—N—N═O₂, wherein i is an integer from 1 to 3 (e.g.: R—N—N═O₂, R₁,R₂—N—N═O₂ or R₁,R₂,R₃—N—NO₂). The one, two or three R groups are each independently selected from the following groups: alkyl; aryl; alkanol; carbonyl; and hydrogen.

Examples of specific nitramine compounds include, but are not limited to: methylnitramine (MeNH—NO₂); ethylnitramine (EtNH—NO₂); dimethylnitramine (Me₂N—NO₂); diethylnitramine (Et₂N—NO₂); MEA-nitramine (HOCH₂CH₂NH—NO₂); AMP-nitramine (HOCH₂C(CH₃)₂NH—NO₂); Morpholine-nitramine; and Piperazine-mono-nitramine.

The gaseous phase is preferable hydrogen gas (H₂) and is preferably provided together with a carrier gas such as nitrogen (N₂) or air.

The heterogeneous hydrogenation catalyst is selected from platina, palladium, nickel and Raney nickel, and is preferably Raney nickel.

A simple system according to the invention is shown in FIG. 1. However, preferably the system of the invention is integrated into a CO₂-absorption system, and possible implementations are presented in FIGS. 2 to 5. As such, the system preferably further comprises an absorber tower, also known as a wet scrubber, and a recovery system for the amine solvent. Amine-based carbon capture of pollutants present in flue gas takes place in the scrubber. The compound-destruction process is preferably integrated with a gas sweetening process (e.g. CO₂-absorption process) that takes place in the wet scrubber system and the chemical reactions are performed in situ (i.e. in the reaction mixture) in order to reduce manual handling.

The removal of nitramines and nitrosamines can be performed in four different implementation schemes:
1) The reactor is connected to the final stage of a scrubber (water wash section), preferably in a loop, such that wash water circulating the upper most section of the scrubber containing an aqueous solution of amines and compounds including nitrosamines and/or nitramines is transferred to the reactor, where the nitrosamines and/or nitramines are destroyed. The chemical destruction process that takes place in the reactor, according to the present invention, produces cleaned water which can be transferred via the loop connection back to the scrubber where it can be recycled. This arrangement is shown in FIG. 2.
2) The reactor is connected to the line feeding fresh amine solution to the gas sweetening tower, preferably in a bypass loop (although not limited to this configuration), such that a partial stream of the solution containing an aqueous solution of amines and compounds including nitrosamines and/or nitramines is circulating through the reactor, where the nitrosamines and/or nitramines are destroyed. This arrangement is shown in FIG. 3.
3) The reactor is connected to the line feeding used (loaded) amine solution to the recovery system (desorption tower), preferably in a bypass loop (although not limited to this configuration), such that a partial stream of the solution containing an aqueous solution of amines and compounds including nitrosamines and/or nitramines is circulating through the reactor, where the nitrosamines and/or nitramines are destroyed. This arrangement is shown in FIG. 4.
4) The reactor is connected to the re-boiler of the recovery system (desorption tower), preferably in a bypass loop (although not limited to this configuration), such that a partial stream of the solution containing an aqueous solution of amines and compounds including nitrosamines and/or nitramines is circulating through the reactor, where the nitrosamines and/or nitramines are destroyed. This arrangement is shown in FIG. 5.

According to a second aspect, the invention provides a process for in-situ destruction of compounds in the aqueous phase from a scrubber system, wherein the process comprises contacting the aqueous phase with a gas phase and a heterogeneous hydrogenation catalyst, wherein the gas phase comprises hydrogen and wherein the aqueous phase comprises (i) a solution of amines; and (ii) nitrosamine and/or nitramine compounds resulting from amine-based gas sweetening. The compounds in the aqueous phase that are destroyed in the claimed process preferably include nitrosamine compounds and nitramine compounds as defined above in relation to the first aspect of the invention.

The reaction preferably takes place within a reactor which is connected to the water wash circulation loop of a CO₂-capture plant. Equivalent alternatives for implementing of the nitrosamine and nitramine removal process includes integration into transfer lines of either lean or loaded absorbent solution, as well as the reboiler section of the recovery system. The process can be operated as a batch process or as a continuous process. If using a batch process, it is preferable for the hydrogen gas (H₂) to be added to a suspension of the aqueous phase and heterogeneous catalyst. Alternatively, if operating a continuous process, it is preferably for the gas and aqueous phases to be fed co-currently or counter-currently to a continuous flow reactor with an immobilized catalyst, a moving bed reactor, a fluidized bed reactor or a bubble column wherein the catalyst is suspended in the fluid.

The process is preferably carried out at a temperature ranging from 4° C. to 150° C. For applications involving a clean solution (e.g. installation between desorber and absorber columns) a temperature of around 25° C., and preferably in the range of 25° C. to 150° C. is sufficient, whereas for applications involving a dirty solution (e.g. installation between absorber and desorber columns) the temperature is preferably higher, for example from 100° C. to 150° C. The process is preferably carried out at a pressure from atmospheric pressure (1 bar(a)) to 150 bar(g), preferably at least 3 bar(g), and a partial pressure of hydrogen of at least 0.01 bar.

Advantageously, the cleaned liquids, which are a product of the process of the invention, can be fed back into the CO₂-capture system and used to form the aqueous phase containing the nitrosamine and/or nitramine compounds.

The process of the invention successfully addresses the objectives of (1) removing and destroying potentially harmful and carcinogenic compounds from sweetened flue gas; (2) recovery of parent amines in the wash water; and (3) reduction of toxicity of waste to be handled from the reactor.

1. A liquid handling system comprising a reactor, wherein the reactor is structured such that it contains a gaseous phase and an aqueous phase, both phases being in contact with a heterogeneous hydrogenation catalyst immobilised or suspended within the aqueous phase, wherein the gaseous phase comprises hydrogen and wherein the aqueous phase comprises (i) a solution of amines; and (ii) nitrosamine and/or nitramine compounds resulting from amine-based gas sweetening processes.

2. A system according to claim 1, wherein the nitrosamine compounds include any compound comprising or characterised by the group NNO and the nitramine compounds include any compound comprising or characterised by the group NNO₂.

3. A system according to claim 1, wherein the nitrosamine compounds include any compound having the general formula Rᵢ—N—N═O, and/or the nitramine compounds include any compound any compound having the general formula Rᵢ—N—N═O₂, wherein i is an integer from 1 to 3.

4. A system according to claim 3, wherein the R groups are each independently selected from the following groups: alkyl; aryl; alkanol; carbonyl; and hydrogen.

5. A system according to claim 1, wherein the heterogeneous catalyst is selected from platina, palladium, nickel and Raney nickel.

6. A system according to claim 1, wherein the gaseous phase further comprises a carrier gas.

7. A system according to claim 1, wherein the system further comprises a wet scrubber connected to the reactor.

8. A system according to claim 7, wherein the reactor is connected to the scrubber via a loop which carries the aqueous phase comprising (i) and (ii) from the scrubber to the reactor and carries cleaned wash water from the reactor to the scrubber.

9. A system according to claim 7, wherein the scrubber is part of a CO₂-absorption system.

10. A process for in-situ destruction of compounds in the aqueous phase from a wet scrubber system, wherein the process comprises contacting the aqueous phase with a gas phase and a heterogeneous hydrogenation catalyst, wherein the gas phase comprises hydrogen and wherein the aqueous phase comprises (i) a solution of amines; and (ii) nitrosamine and/or nitramine compounds resulting from amine-based gas sweetening.

11. A process according to claim 10, wherein the nitrosamine compounds include any compound comprising or characterised by the group NNO and the nitramine compounds include any compound comprising or characterised by the group NNO₂.

12. A process according to claim 10, wherein the nitrosamine compounds include any compound having the general formula Rᵢ—N—N═O, and/or the nitramine compounds include any compound any compound having the general formula Rᵢ—N—N═O₂, wherein i is an integer from 1 to 3.

13. A process according to claim 12, wherein the R groups are each independently selected from the following groups: alkyl; aryl; alkanol; carbonyl; and hydrogen.

14. A process according to claim 10, wherein the gas phase further comprises a carrier gas.

15. A process according to claim 10, wherein the heterogeneous catalyst is selected from platina, palladium, nickel and Raney nickel.

16. A process according to claim 10, wherein the process is a batch process.

17. A process according to claim 16, wherein the catalyst and gas phase are suspended in the aqueous phase.

18. A process according to claim 10, wherein the process is a continuous process.

19. A process according to claim 18, wherein the heterogeneous catalyst is suspended in the aqueous phase or immobilised within a reactor housing the liquid phase.

20. A process according to claim 18, wherein the gas is bubbled through the aqueous phase co-currently or counter-currently.

21. A process according to claim 10, wherein the process is carried out at a temperature from 4° C. to 150° C.

22. A process according to claim 10, wherein the process is carried out at a pressure range from 1 bar(a) to 150 bar(g) and/or a partial pressure of hydrogen of at least 0.01 bar.
